(19) United States
(12) Patent Application Publication
(10) Pub. No.: US 2017/0075686 A1
(43) Pub. Date: Mar. 16, 2017

(54) METHOD FOR UPDATING LIBRARY, AND TERMINAL AND SYSTEM THEREFOR

(71) Applicant: SK TECHX CO., LTD., Seoul (KR)

(72) Inventor: Youngkoan KO, Bucheon-si, Gyeonggi-do (KR)

(21) Appl. No.: 15/310,516

(22) PCT Filed: Jan. 13, 2015
(86) PCT No.: PCT/KR2015/000348

§ 371 Date: Nov. 11, 2016

(30) Foreign Application Priority Data
May 15, 2014 (KR) 10-2014-0058317

(51) Int. Cl. G06F 9/44; G06F 9/445

(52) U.S. Cl. CPC G06F 8/70; G06F 8/54

(57) ABSTRACT

The present invention relates to a method for updating a library in a terminal environment comprising a shared storage area accessible by multiple applications and non-shared storage areas allocated to each application. More specifically, the shared storage area comprises a child library which can be utilized by all applications, the non-shared storage area comprises a parent library executed for each application, and the method for updating a library can control so that the parent library compares the version of the child library by linking to a service apparatus and, if an updated is needed, child library-related files from the service apparatus is received so that the child library can be made functional.

### CROSS REFERENCE TO RELATED APPLICATION

This present application is a national stage filing under 35 U.S.C §371 of PCT application number PCT/KR2015/000348, filed Jan. 13, 2015 which is based upon and claims the benefit of Korean Patent Application No. 10-2014-0058317, filed May 15, 2014, which is hereby incorporated by reference in its entirety into this application.

### TECHNICAL FIELD

The present invention relates, in general, to a method for updating a library in a terminal environment including a shared storage area, which is accessible by multiple applications, and a non-shared storage area, allocated to each of the applications, and, more particularly, to a method for updating a library, and a terminal and system for the method, configured such that the shared storage area includes a child library that all applications may use, such that the non-shared storage area includes a parent library executed for each application, and such that the parent library may receive a file related to the child library from a service device and control the received file so as to be used in place of the child library when it is determined that it is necessary to update the child library as a result of comparison of the version of the child library with the version of the library in the service device, which is performed in conjunction with the service device.

### BACKGROUND ART

The description made in this section merely provides background information on the present embodiment and does not comprise a conventional art.

Recently, with the performance improvement of terminals, such as smartphones or the like, and the rapid development of communication technology, various kinds of applications capable of being run on the terminals have rapidly propagated, and various methods for developing applications have been introduced.

These days, code and resources commonly used by multiple applications are configured and developed as separate subprograms. Such a subprogram is called a “library”. Application developers provide a Software Development Kit (SDK) in the form of a library to increase the efficiency of the development process.

Here, the written SDK library is built by being included in a developer's application and is then released, and may be executed along with the application code in the run-time process.

Because an SDK library is released by being included in each application that uses the library, it is problematic in that a plurality of identical SDK libraries may be present in a single terminal.

Also, because an entire SDK library is released by being included in an application, it is problematic in that a lot of network resources are consumed when the application is transmitted.

Also, because an SDK library is included in an application when the application is built, if the SDK library is updated, additional expense is required in order to rebuild and release the application.

### DISCLOSURE

### Technical Problem

The present invention has been proposed to solve the above-mentioned existing problems, and an object of the present invention is to provide a method for updating a library, and a terminal and system for the method, configured such that, in a terminal environment including a shared storage area accessible by multiple applications and a non-shared storage area allocated to each of the applications, the shared storage area includes a child library that can be used by all the applications, the non-shared storage area includes a parent library executed for each of the applications, and the parent library compares the version of the child library with the version of a library within a service device, receives a file related to the child library when it is determined that it is necessary to update the child library, and performs control such that the received file is used in place of the child library.

However, the object of the present invention is not limited to the above-mentioned object, and other objects that have not been mentioned will be clearly understood from the following description.

### Technical Solution

In order to accomplish the above object, a terminal according to an embodiment of the present invention may be configured to include a storage unit including a non-shared storage area allocated to each application and a shared storage area shareable by multiple applications, the non-shared storage area including a parent library that is allocated to each application and is capable of accessing and using a child library, and the shared storage area including the child library, shared by the multiple applications, for providing resources to the parent library; and a control unit for checking a version of a library within a service device by controlling the parent library allocated to an application when the application is run, for comparing the checked version with a version of the child library within the shared storage area, for receiving a file related to the library from the service device by controlling the parent library when the checked version is found to differ from the version of the child library, for controlling the received file so as to be stored in the shared storage area, and for performing control so as to replace the child library previously stored in the shared storage area with the received library.

Here, after controlling the received library so as to be stored in the shared storage area, the control unit may control processes of creating a class of the child library simultaneously with creating a class of the parent library, creating an object through the created class of the parent library, and retrieving and calling a method through the created object in order to perform a function provided by the received library.

In order to accomplish the above object, a terminal according to an embodiment of the present invention may be configured to include a child library, located in a shared storage area shareable by multiple applications, for providing resources in response to a request from one or more parent libraries; and the one or more parent libraries, located in a non-shared storage area allocated to each application, for checking a version of a library within a service device by operating in conjunction with the service device when an application is run, for receiving a file related to the library from the service device when the checked version is found to differ from a version of the child library as a result of a comparison therebetween, for controlling the received file so as to be stored in the shared storage area, and for performing control so as to replace the child library previously stored in the shared storage area with the received library.

Here, the parent library may be configured to include a child library management unit for determining whether the child library is updated; a child library loading unit for storing the library, received from the service device, in the shared storage area; and a child library call unit for creating an object by retrieving a class and for retrieving and calling a method through the created object, in order to make the library stored in the shared storage area operate as the child library.

Here, the child library management unit may be configured to include a server connection unit for connecting to the service device; a version checking unit for checking the version of the library within the service device by querying the version when the service device is connected through the server connection unit; and a storage area connection unit for connecting to the storage area after checking whether the library of the service device is shared among multiple applications when the version of the library, checked by the version checking unit, is found to differ from the version of the child library as a result of a comparison therebetween.

Here, the storage area connection unit may determine that the child library is shared among multiple applications if one or more applications use the child library when checking applications using the previously stored child library.

In order to accomplish the above object, a system for updating a library according to an embodiment of the present invention may be configured to include a service device for storing and managing a library that is capable of being used by one or more applications; and a terminal including a non-shared storage area, which includes a parent library that is allocated to each of the applications and is capable of accessing and using a child library, and a shared storage area, which includes the child library, shared among the multiple applications, for providing resources to the parent library, the terminal being configured to check a version of the library within the service device by controlling the parent library allocated to an application when the application is run, to compare the checked version with a version of the child library within the shared storage area, to receive a file related to the library from the service device by controlling the parent library when the checked version is found to differ from the version of the child library, to control the received file so as to be stored in the shared storage area, and to perform control so as to replace the child library previously stored in the shared storage area with the received library.

In accordance with an embodiment of the present invention to accomplish the above object, there is provided a method for updating a library in an environment of a terminal including a non-shared storage area, which includes a parent library that is allocated to each application and is capable of accessing and using a child library, and a shared storage area, which includes the child library, shared among multiple applications, for providing resources to the parent library, the method including checking, by the terminal, a version of a library within a service device by controlling the parent library allocated to an application when the application is run; comparing, by the terminal, the checked version with a version of the child library within the shared storage area; receiving, by the terminal, a file related to the library from the service device by controlling the parent library when the checked version is found to differ from the version of the child library; and controlling, by the terminal, the received file related to the library so as to be stored in the shared storage area and controlling, by the terminal, the received library so as to replace the child library previously stored in the shared storage area.

In accordance with an embodiment of the present invention to accomplish the above object, there is provided a method for updating a library in an environment of a terminal including a non-shared storage area, which includes a parent library that is allocated to each application and is capable of accessing and using a child library, and a shared storage area, which includes the child library, shared among multiple applications, for providing resources to the parent library, the method including checking, by the parent library, a version of a library within a service device by operating in conjunction with the service device when an application to which the parent library is allocated is run; comparing, by the parent library, the checked version with a version of the child library; and when the checked version is found to differ from the child library as a result of the comparing, performing, by the parent library, control so as to receive a file related to the library from the service device and to store the received file in the shared storage area and performing, by the parent library, control so as to replace the child library previously stored in the shared storage area with the received library.

Here, performing control may include storing, by the parent library, the received library in the shared storage area; creating, by the parent library, a class of the child library simultaneously with creating a class of the parent library in order to perform a function provided by the received library; and controlling, by the parent library, processes of creating an object through the created class of the child library and retrieving and calling a method through the created object.

Also, after comparing the checked version with the version of the child library, the method may further include connecting, by the parent library, to the storage area after checking whether the library of the service device is shared among multiple applications when the checked version is found to differ from the child library as a result of the comparing.

Additionally, the present invention may provide a computer-readable recording medium in which a program for performing the above-described method for updating a library is recorded.

### Advantageous Effects

According to the method for updating a library, and a terminal and system for the method of the present invention, a terminal environment is implemented so as to include a shared storage area accessible by multiple applications and a non-shared storage area allocated to each of the applications, the shared storage area includes a child library that all applications may use, and the non-shared storage area includes a parent library executed for each of the applications, whereby the duplication of libraries in the terminal may be prevented and the resources of the terminal may be more effectively used.

Also, because only a parent library, configured with APIs for accessing a child library including classes, methods and objects for implementing actual functions, is released by being included in an application, the size of the application may be reduced, whereby network resources may be more effectively used.

Also, when it is necessary to update a child library, in which actual functions are implemented, only the child library, accessible and shareable by multiple applications, is updated without the need to update the respective applications, whereby it is advantageous in that the expense incurred for the maintenance of the applications may be reduced.

Further, various effects, other than the above-mentioned effects, may be directly or implicitly disclosed in the following detailed description according to an embodiment of the present invention.

### DESCRIPTION OF DRAWINGS

FIG. 1 is a schematic block diagram of an application provision system to which a method for updating a library according to an embodiment of the present invention is applied;

FIG.2 is a block diagram that shows the main components of the terminal shown in FIG. 1 according to an embodiment of the present invention;

FIG. 3 is a block diagram that shows the configuration of a storage unit according to an embodiment of the present invention;

FIG. 4 is a block diagram that shows the main components of a parent library according to an embodiment of the present invention;

FIG. 5 is a block diagram that shows the main components of a child library according to an embodiment of the present invention;

FIG. 6 is a block diagram that shows the main components of the service device shown in FIG. 1 according to an embodiment of the present invention;

FIG. 7 is a flowchart for describing the process of receiving a library file from a service device in order to update a library according to an embodiment of the present invention;

FIG. 8 is a flowchart for describing a method for importing a library file into a child library according to an embodiment of the present invention; and

FIG. 9 is a flowchart for describing a method in which a parent library uses an updated child library according to an embodiment of the present invention.

FIG. 10 is a process of calling a method in a child library through a created class in the child library according to an embodiment of the present invention.

### BEST MODE

Hereinafter, a preferred embodiment of the present invention is described in detail with reference to the accompanying drawings so that those having ordinary knowledge in the technical field to which the present invention pertains can easily practice the present invention. However, in the following description of a preferred embodiment of the present invention, if detailed descriptions of known functions and configurations are deemed to make the gist of the present invention obscure, the detailed descriptions will be omitted. This is intended to more clearly deliver the gist of the present invention by omitting unnecessary description. Also, because the present invention may be variously changed, and may have various embodiments, specific embodiments will be described in detail with reference to the attached drawings. However, it should be understood that those embodiments are not intended to limit the present invention to specific disclosure forms and that they include all changes, equivalents or modifications included in the spirit and scope of the present invention.

Also, terms including ordinal numbers, such as “first”, “second”, etc., can be used to describe various elements and to differentiate one element from the other, but the elements should not be limited by these terms. For example, the first element may be referred to as the second element, and similarly, the second element may be referred to as the first element, without departing from the scope of the present invention.

Further, when a first element is described as being “connected” or “coupled” to a second element, it may indicate that the first element is logically or physically connected or coupled to the second element. In other words, the first element may be directly connected or coupled to the second element, but it should be understood that some other elements may be interposed therebetween, or that the first element may be indirectly connected or coupled to the second element.

Also, terms used in the present specification are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, a method for updating a library, and a terminal and system for the method according to an embodiment of the present invention, will be described in detail with reference to the drawings. In the following description, the same reference numerals are used to designate a part for performing the same or similar functions and operations throughout the drawings, and repeated descriptions thereabout will be omitted.

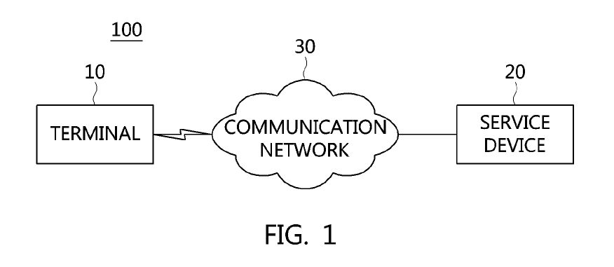

FIG. 1 is a schematic block diagram of an application provision system to which a method for updating a library according to an embodiment of the present invention is applied.

Referring to FIG. 1, a library update system 100 according to an embodiment of the present invention may be configured to include a terminal 10, a service device 20, and a communication network 30 for sending and receiving information between the terminal 10 and the service device 20.

Schematically describing each of the components, first, the terminal 10 means a user's device capable of sending and receiving various data via the communication network 30 depending on the manipulation by a user. The terminal 10 may perform voice or data communication through the communication network 30, and may send and receive various kinds of information to and from the service device 20. To this end, the terminal 10 of the present invention may include a browser for sending and receiving information, memory for storing programs and protocols therein, a microprocessor for performing operation and control by running various kinds of programs, and the like.

Particularly, the terminal 10 according to an embodiment of the present invention includes a storage unit, and the storage unit includes a non-shared storage area allocated to each application and a shared storage area shareable by multiple applications. Here, the non-shared storage area may include a parent library, which is allocated to each application, and through which a child library may be accessed and used, and the shared storage area may include the child library, shared by multiple applications, for providing resources to the parent library.

When such a storage environment is implemented, if any one application is run, the terminal 10 of the present invention checks the version of the library within the service device 20 by controlling the parent library allocated to the application, and may receive a file related to the library from the service device 20 if the checked version is found to differ from the version of the child library included in the shared storage area as a result of the comparison therebetween. Also, the terminal 10 may control the parent library allocated to the run application in order to store the library received from the service device 20 in the shared storage area, and may thereby replace the child library previously stored in the shared storage area with the received library.

A more specific description of the storage environment and the library update method in the terminal 10 will be made later.

The service device 20 manages a library, which is a set of resources, such as classes, methods and objects capable of performing specific functions according to an embodiment of the present invention, and provides the library in response to a request from the terminal 10. Particularly, the service device 20 may control the processes of including a library in an application and releasing the application and may provide a library capable of performing a specific function, for example, a library for an advertisement service, in response to a request from an application within the terminal 10.

Furthermore, a library, which is a set of resources capable of performing a specific function provided by the service device 20, may be frequently updated, and the updated library may be provided to the terminal 10 so as to support the overall process of executing the child library in the terminal 10.

A more specific description of the main components and operation method of the service device 20 will be made later, and a processor installed in the terminal 10 and the service device 20 according to an embodiment of the present invention may process program instructions for performing the method according to the present invention. This processor may be a single-threaded processor in an embodiment, or may be a multi-threaded processor in another embodiment. Further, this processor may process instructions stored in memory or a storage device.

Also, the terminal 10 and service device 20 according to an embodiment of the present invention send and receive various kinds of information via the communication network 30, and in this case, various forms of communication networks may be used as the communication network 30.

For example, a wireless communication method using Wireless LAN (WLAN), Wi-Fi, Wibro, Wimax, High Speed Downlink Packet Access (HSDPA) or the like, or a wired communication method using Ethernet, xDSL (ADSL or VDSL), Hybrid Fiber Coaxial Cable (HFC), Fiber To The Curb (FTTC), Fiber To The Home (FTTH), or the like, may be used. Also, all kinds of communication methods that are widely known or have yet to be developed may be included, in addition to the above-mentioned communication methods.

Hereinafter, the main components and operation method of the terminal 10 according to an embodiment of the present invention will be described.

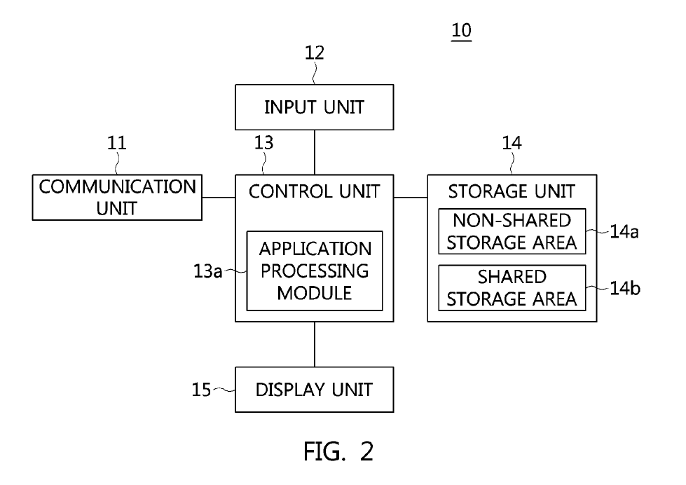

FIG. 2 is a block diagram that shows the main components of the terminal illustrated in FIG. 1 according to an embodiment of the present invention.

Referring to FIG. 1 and FIG. 2, the terminal 10 according to an embodiment of the present invention may be configured to include a communication unit 11, an input unit 12, a control unit 13, a storage unit 14 and a display unit 15.

More specifically describing each of the components, first, the communication unit 11 serves to send and receive various kinds of information to and from the service device 20 via the communication network 30. Specifically, the communication unit 11 according to an embodiment of the present invention may receive a file related to a library provided from the service device 20, and may support the process of querying the service device 20 about the version of the library.

The input unit 12 delivers various kinds of information input by a user, such as numbers, characters and the like, and signals that are input in order to set and control various functions of the terminal 10 to the control unit 13. Particularly, the input unit 12 of the present invention may provide a user input means through which an application for performing a specific function may be run.

The above-described input unit 12 may include a key input unit, such as a keyboard or a keypad, a touch input unit, such as a touch sensor or a touch pad, a voice input unit, and a gesture input unit, which includes at least one of a Gyro sensor, a geomagnetic sensor, an acceleration sensor, a proximity sensor and a camera.

In addition to these examples, all forms of input units that are currently being developed or have yet to be developed may be included.

The control unit 13 performs the overall control of the terminal 10, and may be configured to include at least one processor including a Central Processing Unit (CPU)/Micro Processing Unit (MPU), memory into which one or more pieces of data are loaded and processed (for example, registers and/or Random Access Memory (RAM)), and a bus for inputting and outputting one or more pieces of data from and to the processor and memory in the aspect of hardware, and to include predetermined program routines or program data, which are loaded from a predetermined recoding medium into the memory and processed by the processor in order to perform the functions defined in the terminal 10, in the aspect of software. In other words, the components that can be realized via software may be defined as the function of the control unit 13, among the functions for performing the method for updating a library according to an embodiment of the present invention in the terminal 10.

The control unit 13 of the present invention is functionally connected with at least one component provided in order to provide the method for updating a library according to an embodiment of the present invention. That is, the control unit 13 is functionally connected with the communication unit 11, the input unit 12, the storage unit 14 and the display unit 15, and controls the flow of signals for supplying power to each of the components and performing functions. The control unit 13 is configured to include an application processing module 13a and supports the process of storing and installing one or more applications in the storage unit 14. Also, when the installed application is run, the control unit 13 may send, receive and process various kinds of information related to the corresponding application.

Particularly, when any one application is run, the control unit 13 according to an embodiment of the present invention may check the version of a library within the service device 20 through the communication unit 11 by controlling the parent library assigned to the application, receive a file related to the library from the service device 20 by controlling the parent library when the checked version is found to differ from the version of the child library stored in the shared storage area 14b of the storage unit 14 as a result of the comparison therebetween, store the received file in the shared storage area 14b of the storage unit 14, and replace the child library previously stored in the shared storage area 14b with the received library.

After storing the library received from the service device 20 in the shared storage area 14b of the storage unit 14 in order to replace the previously stored child library, the control unit 13 may control the processes of creating a class of the child library simultaneously with creating a class of the parent library, accessing the class of the child library by calling a method through the created class of the parent library, and calling a corresponding method in order to perform the function provided by the received library.

The operation in the control unit 13 will be described in connection with the operation method of the child library and parent library stored in the storage unit 14.

The storage unit 14 may store programs required to perform functions according to an embodiment of the present invention, and may temporarily store various data generated during the execution of programs. Also, the storage unit 14 may include a program area and a data area. The program area stores information related to the operation of the terminal 10, such as an Operating System (OS) related to the booting process of the terminal 10. The data area may store data generated while the terminal 10 is used, and may be divided into the above-mentioned non-shared storage area 14a and shared storage area 14b. The storage unit 14 may be configured to include storage media such as flash memory, a hard disk, multimedia card micro-type memory (for example, SD or XD memory), RAM, ROM and the like.

Particularly, the storage unit 14 according to an embodiment of the present invention may be divided into the non-shared storage area 14a allocated to each application and the shared storage area 14b for storing resources accessible by multiple applications.

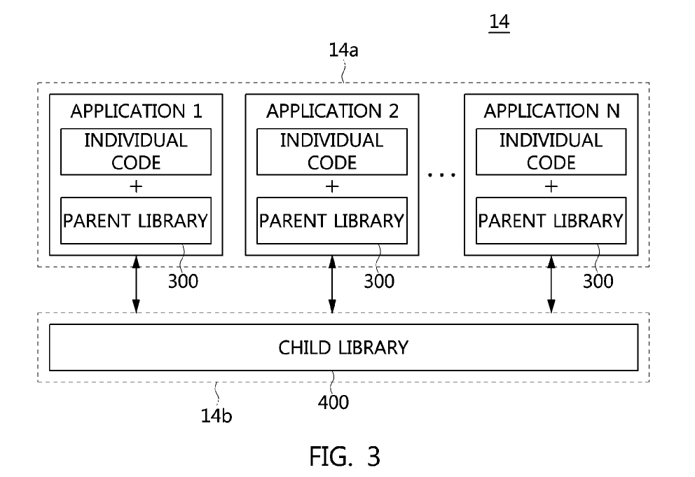

In this regard, a more specific description will be made with reference to FIG. 3.

FIG. 3 is a block diagram that shows the configuration of a storage unit according to an embodiment of the present invention.

Referring to FIG. 3, the storage unit 14 according to an embodiment of the present invention may be divided into a non-shared storage area 14a allocated to each application and a shared storage area 14b for storing data shared among multiple applications, as described above.

First, the non-shared storage area 14a is allocated to each application, and is an area for storing data for each application. The size of the non-shared storage area 14a may be increased or decreased depending on the number of applications installed in the terminal 10.

Also, one or more applications present in the non-shared storage area 14a include individual code for storing their own data and a parent library 300. Here, the parent library 300 is a library included in an application when the application is developed by an application developer, and provides an Application Programming Interface (API) for calling a library. However, the actual function that can be executed by calling the API is not present in the parent library 300 but is present in the resources of the child library 400. That is, the parent library 300 merely serves to support access to the child library.

The shared storage area 14b, which is accessible by multiple applications and stores resources that can be used by the multiple applications, includes a child library 400. The child library, which provides resources for providing actual functions to an application, may be used by being linked to a parent library included in each application, and may be stored and managed in the shared storage area 14b, along with information such as a library version, file information, and the like.

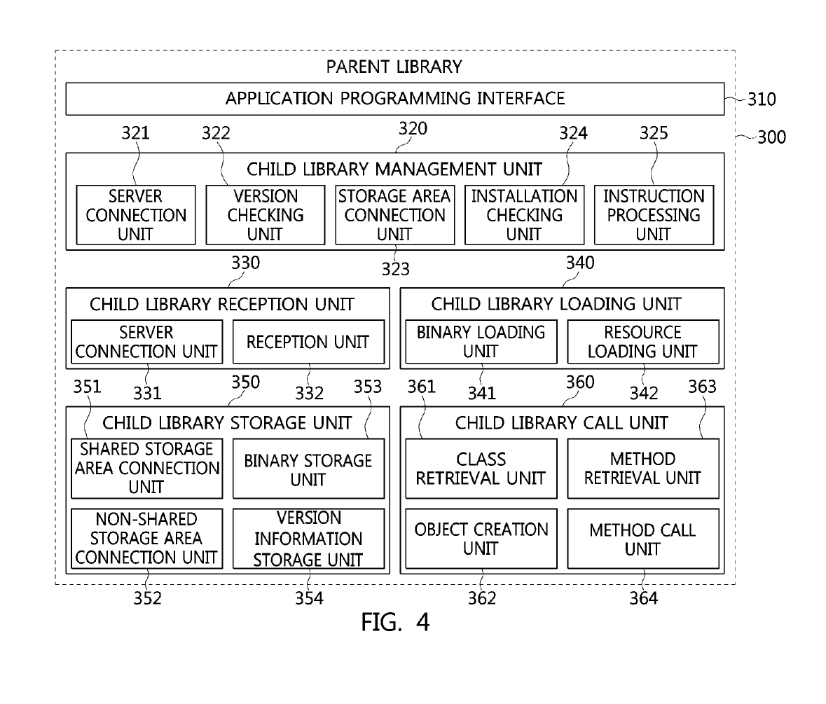

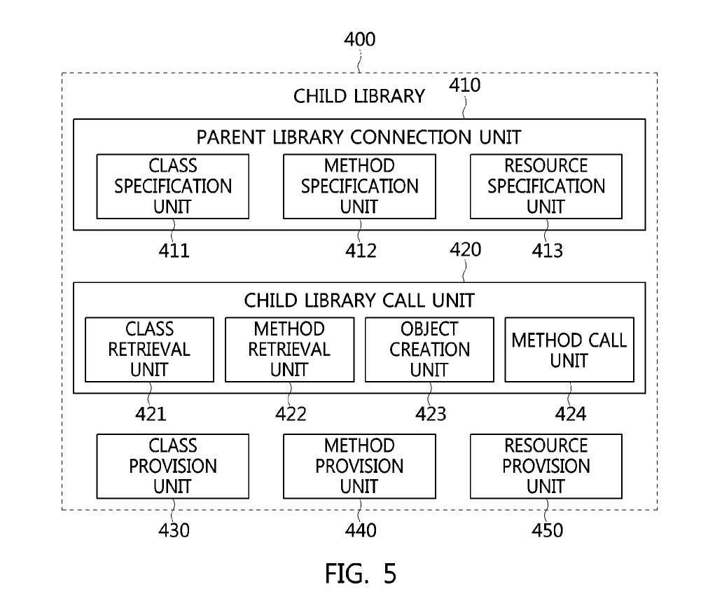

The main components and roles of the parent library and child library will be described in detail with reference to FIG. 4 and FIG. 5.

FIG. 4 is a block diagram that shows the main components of a parent library according to an embodiment of the present invention.

Referring to FIG. 4, the parent library 300 may be configured to include an application programming interface 310, a child library management unit 320, a child library reception unit 330, a child library loading unit 340, a child library storage unit 350, and a child library call unit 360. Here, these are logical categories, and the actual operations thereof may be performed in conjunction with the control unit 13 and the communication unit 11.

Specifically describing each of the components, the application programming interface 310 supports the process of accessing the child library.

The child library management unit 320 may be configured to include a server connection unit 321, a version checking unit 322, a storage area connection unit 323, an installation checking unit 324 and an instruction processing unit 325. The server connection unit 321 of the child library management unit 320 serves to establish a connection with the service device 20. The version checking unit 322 serves to check the version of a library within the service device 20 when a connection with the service device 20 is established through the server connection unit 321.

The storage area connection unit 323 compares the version of the library with the version of the child library installed in the terminal 10, that is, the version of the child library stored in the shared storage area 14b of the storage unit 14. When the two versions are found to differ from each other as a result of the comparison, the storage area connection unit 323 determines whether the library within the service device 20 is shared among multiple applications, and establishes a connection in order to store the library in the shared storage area 14b or in the non-shared storage area 14a depending on the result of the determination.

The installation checking unit 324 serves to check the version of the library within the terminal 10 in conjunction with the storage area connection unit 323 in response to a request from the storage area connection unit 323. The instruction processing unit 325 may be configured with instructions required for performing operations such as the reception, storage, call and the like, as described above.

In order to receive a library to be updated from the service device 20 in response to a request from the child library management unit 320, the child library reception unit 330 may be configured to include a server connection unit 331 for connecting to the service device 20 and a reception unit 332 for receiving a library.

The child library loading unit 340 serves to read and load a library and to load resources included in the library file according to loading instructions from the child library management unit 320. The child library loading unit 340 may be configured to include a binary loading unit 341 and a resource loading unit 342. Here, the binary loading unit 341 serves to load a library file in the form of binary code, and the resource loading unit 342 serves to load resources included in the library file.

The child library storage unit 350 may be configured to include a shared storage area connection unit 351, a non-shared storage area connection unit 352, a binary storage unit 353 and a version information storage unit 354. The shared storage area connection unit 351 and the non-shared storage area connection unit 352 provide an interface between the shared storage area 14b and the non-shared storage area 14a, the binary storage unit 353 stores a library file, and the version information storage unit 354 stores and manages the version of a library and file information.

The child library call unit 360 serves to create an object by retrieving a class from the loaded library, to retrieve a method through the created object, and to call the method. The child library call unit 360 may be configured to include a class retrieval unit 361 for retrieving a class, an object creation unit 362 for creating an object using the retrieved class, a method retrieval unit 363 for retrieving a method through the created object, and a method call unit 364 for calling the retrieved method.

Hereinafter, the main components and roles of the child library will be described.

FIG. 5 is a block diagram that shows the main components of a child library according to an embodiment of the present invention.

Referring to FIG. 5, the child library 400 may be configured to include a parent library connection unit 410, a child library call unit 420, a class provision unit 430, a method provision unit 440 and a resource provision unit 450.

The parent library connection unit 410 provides a function for connection with a parent library 300, and the parent library 300 may search the child library 400 for an accessible object through a class specification unit 411, a method specification unit 412, and a resource specification unit 413.

The child library call unit 420 provides a component through which a class and method may be retrieved, created and called based on the specification obtained using the parent library connection unit 410. The child library call unit 420 is configured to include a class retrieval unit 421, a method retrieval unit 422, an object creation unit 423 and a method call unit 424.

The class provision unit 430, the method provision unit 440, and the resource provision unit 450 serve to provide the parent library 300 with classes, methods and resources through which actual functions are implemented in the child library 400.

The method for updating a library through an interconnection between the parent library 300 and the child library 400 is more specifically described with reference to the following flowchart. Again referring to FIG. 2, the component of the terminal 10 will be described below.

The display unit 15 displays information about states and results of operations while functions of the terminal 10 are performed. Particularly, the display unit 15 of the present invention may output various kinds of information generated during the execution of an application, for example, information about a specific function provided by a child library.

The display unit 15 may be implemented in the form of a single touch panel (or a touch screen) by being integrated with the input unit 12 as described above, and may display various kinds of information generated by a touch operation performed by a user when it is implemented by being integrated with the input unit 12.

Also, the above-described display unit 15 of the present invention may be configured with a Liquid Crystal Display (LCD), a Thin Film Transistor LCD (TFT-LCD), an Organic Light Emitting Diode (OLED), an LED, an Active Matrix Organic LED (AMOLED), a flexible display, a 3-dimensional display, or the like. Also, some of these displays may be implemented as a transparent type or a translucent type. The latter may be implemented in the form of a transparent display that includes a Transparent OLED (TOLED).

Hitherto, the main components of the terminal 10 have been described with reference to FIG. 2. However, not all the components illustrated in FIG. 2 are essential components, and the terminal 10 may be implemented so as to have more components than the number of illustrated components, or to have less components than that. For example, the terminal 10 may be configured to further include a sound source output unit (not illustrated) for transforming a sound source, which is an electrical signal, into an analog signal and outputting the transformed signal.

Also, the locations of the main components of the terminal 10 illustrated in FIG. 2 may be changed for convenience or some other reason. Also, only an application processing module 13a is illustrated as a module of the control unit 13, but without limitation thereto, the control unit 13 may be configured with various modules for performing various functions.

Hitherto, the main components and operation method of the terminal 10 according to an embodiment of the present invention have been described. The terminal 10 of the present invention may be implemented in various forms. For example, the terminal 10 described in this specification may be a mobile terminal, such as a smart phone, a tablet PC, a Personal Digital Assistant (PDA), a Portable Multimedia Player (PMP), an MP3 Player, or the like, or a stationary terminal, such as a smart TV, a desktop computer, or the like.

Although not all mobile devices may be enumerated as examples of the terminal 10 of the present invention because mobile devices are variously changed with the trend of convergence of digital devices, a unit having the same level as the above-mentioned units may be used as the terminal 10 of the present invention. Also, any terminal that has a storage unit 14 and is capable of sending and receiving information to and from the service device 20 via the communication network 30 may be used as the terminal 10 of the present invention.

Hereinafter, the main components and operation method of the service device 20 according to an embodiment of the present invention will be described.

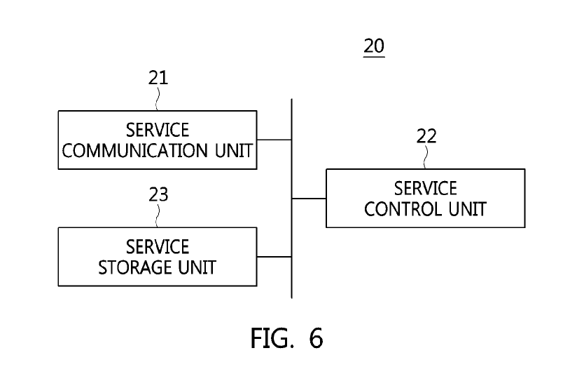

FIG. 6 is a block diagram that shows the main components of a service device according to an embodiment of the present invention, which is illustrated in FIG. 1.

Referring to FIGS. 1 and 6, the service device 20 according to an embodiment of the present invention may be configured to include a service communication unit 21, a service control unit 22 and a service storage unit 23.

Specifically describing each of the components, first, the service communication unit 21 serves to send and receive various kinds of information to and from one or more terminals 10 via the communication network 30. Particularly, the service communication unit 21 of the present invention may receive a query about the version of a library from any one terminal 10, and may provide the version of the library to the corresponding terminal 10.

The service control unit 22 performs the overall control of the service device 20 according to an embodiment of the present invention, and specifically, the service control unit 22 according to an embodiment of the present invention may serve to store and manage a library to be provided to one or more terminals 10. Here, the library is different from a parent library, which is released by being included in an application when the application is released, and may be a set of classes, methods and objects for providing a designated function through an application. When this library is installed in the terminal 10, it operates as a child library that may be linked with a parent library. The service control unit 22 stores and manages a library in order to perform the above-mentioned process, and helps the process of distributing the libraries to terminals 10. The service control unit 22 may receive a query about the version of a library from any one terminal 10, and may provide information about the version of the library to the corresponding terminal 10 in response to the query. Also, the service control unit 22 may provide a library stored therein to a terminal 10 in response to a request from the terminal 10.

The service storage unit 23 stores all programs for performing the functions of the service device 20. Particularly, the service storage unit 22 according to the present invention may store and manage a library, which is a set of resources for performing a designated function (for example, an advertisement service).

The service storage unit 23 of the present invention may be a storage unit located in the service device 20, or may be a data storage server, located outside the service device 20, for sending and receiving data to and from the service device 20.

Hitherto, the main components and operation method of the service device 20 according to an embodiment of the present invention have been described.

From the aspect of hardware, the service device 20 according to an embodiment of the present invention has the same configuration as a common web server or network server. However, from the aspect of software, it includes a program module, which is implemented using languages such as C, C++, Java, Visual Basic, Visual C and the like. The service device 20 may be implemented in the form of a web server or network server. Generally, a web server means a computer system, connected with multiple unspecified clients and/or other servers through an open computer network, such as the Internet, for receiving a request for performing work from the clients or other servers and producing and providing a working result in response thereto, and computer software (a web server program) installed therein for the same purpose. However, in addition to the above-mentioned web server program, it may be understood according to a wide concept including an application run on the web server and various kinds of databases constructed therein according to the circumstances. This service device 20 may be implemented using a web server program on common server hardware, and the web server program may be variously provided depending on the OS, such as DOS, Windows, Linux, UNIX, Mac OS, and the like. As a representative web server, WebSite or Internet Information Server (IIS) used in a Windows environment, or CERN, NCSA, or APACHE used in a UNIX environment may be used. Also, the service device 20 classifies service subscription information so as to be stored in a membership database and manages the stored information, in which case the database may be implemented in the service device 20 or on the outside thereof. Here, the database implemented within the service device 20 may correspond to the service storage unit 23.

Also, the service device 20 of the present invention may be implemented as one or more servers that operate using a server-based computing method or using a cloud computing method. Particularly, information sent and received using the library update system 100 may be provided using a cloud computing function, through which the information may be permanently stored in a cloud computing device on the Internet. Here, “cloud computing” means technology for providing Information Technology (IT) resources, which are virtualized using Internet technology, for example, hardware (a server, storage, a network and the like), software (a database, security features, a web server and the like), services, data and the like, to digital terminals, such as desktop computers, tablet PCs, laptops, netbooks, smart phones and the like, based on an on-demand method. In the present invention, all information sent and received between the service device 20 and one or more terminals 10 is stored in the cloud computing device on the Internet, and may thus be transmitted to any place at any time.

Meanwhile, memory installed in the terminal 10 or service device 20 stores information therein. In an embodiment, the memory is a computer-readable recording medium. The memory may be a volatile memory unit in an embodiment, or the memory may be a non-volatile memory unit in another embodiment. In an embodiment, a storage device is a computer-readable recording medium. In different embodiments, the storage device may include, for example, a hard disk device, an optical disk device, or any other mass storage device.

Furthermore, the term “module” used in an embodiment of the present invention means a software component, and such a module performs certain roles. For example, a module includes components, such as software components, object-oriented software components, class components and task components, processes, functions, attributes, procedures, subroutines, segments of program code, drivers, data, databases, data structures, tables, arrays and variables. Also, components and functions provided in modules may be combined into smaller numbers of components and modules, or may be divided into modules, along with additional components.

Although an exemplary device configuration is described in this specification and drawings, embodiments of functional operations and subject matters described in this specification may be implemented in different types of digital electronic circuitry, implemented in computer software, firmware, or hardware, which includes the structure disclosed herein and its structural equivalents, or may be implemented in a combination of one or more of these. Embodiments of the subject matter described in this specification may be implemented as one or more computer program products, that is, one or more modules related to computer program instructions encoded in a tangible program storage medium in order to control the operation of a device according to the present invention or to be run by the device. The computer-readable storage medium may be a machine-readable storage device, a machine-readable storage board, a memory device, a composition of material having an influence on a machine-readable radio wave signal, or a combination of one or more of these.

Hereinafter, a method for updating a library according to an embodiment of the present invention will be described.

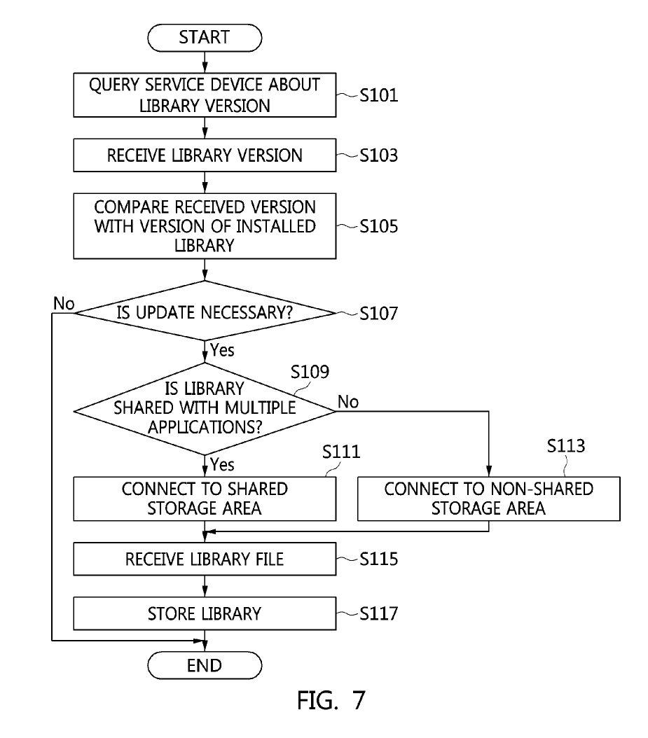

FIG. 7 is a flowchart for describing the process of receiving a library file from a service device in order to update a library according to an embodiment of the present invention.

Referring to FIGS. 1 to 7, first, the control unit 13 of the terminal 10 queries the version of the library stored on the service device 20 through a parent library stored in the non-shared storage area 14a of the storage unit 14 at step S101 and receives the version of the library stored on the service device 20 at step S103. More specifically, in response to a request from the control unit 13, the child library management unit 320 of the parent library 300 connects to the service device 20 through the server connection unit 321 and queries the service device 20 about the version of the library through the version checking unit 322, and the version checking unit 322 may receive the version of the library from the service device 20 through the server connection unit 321.

Then, in response to a request from the control unit 13 of the terminal 10, the parent library, more specifically, the storage area connection unit 323 of the parent library 300, checks the version of the installed library through the installation checking unit 324, and when the version of the installed library is found to differ from the library within the service device 20, the purpose of the library within the service device 20 is checked at steps S105 to S109.

In other words, if the library within the service device 20 is a library to be shared among multiple applications, the storage area connection unit 323 connects to the shared storage area at step S111, but if not, it connects to the corresponding non-shared storage area, in which the parent library 300 is stored, at step S113.

Subsequently, in response to a request from the control unit 13, a library file is received through the child library reception unit 330 of the parent library 300 at step S115, and the received library file is stored in the shared storage area 14b through the child library storage unit 350 at step S117.

The process of importing the library file stored in the shared storage area 14b to the child library will be described hereinafter.

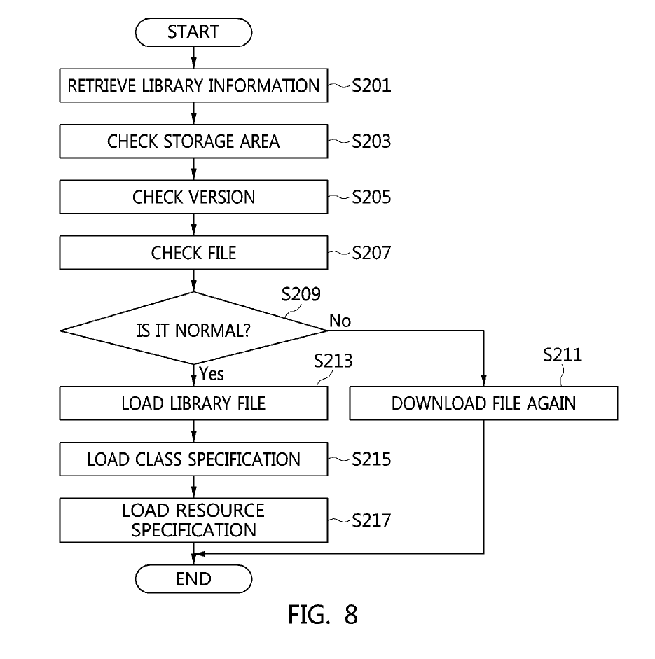

FIG. 8 is a flowchart for describing a method for importing a library file to the child library according to an embodiment of the present invention.

Referring to FIGS. 1 to 8, when any one application is run, the parent library 300 included in the corresponding application checks at step S201 information related to the library, which is newly installed in the shared storage area 14b, such as the version of the library, the file name of the library and the like, in response to a request from the control unit 13 of the terminal 10. Then, because the library is located in the shared storage area 14b, the parent library 300 checks an accessible storage area at step S203 in order to check whether the corresponding application can access the shared storage area 14b, checks whether the file corresponding to the version is present therein at step S207, loads the library file at step S213 when it is determined at step S209 that no error is present in the corresponding library file, and loads a class specification and a resource specification at steps S215 to S217. However, when it is determined at step S209 that an error is present in the library received from the service device 20, the parent library 300 may delete the library stored in the shared storage area 14b and download it again at step S211.

Through these processes, the parent library 300 of the run application may use the new child library, for example, may access a class through the child library and call a method through the corresponding class.

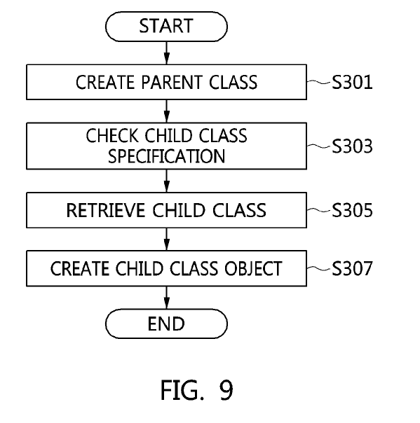

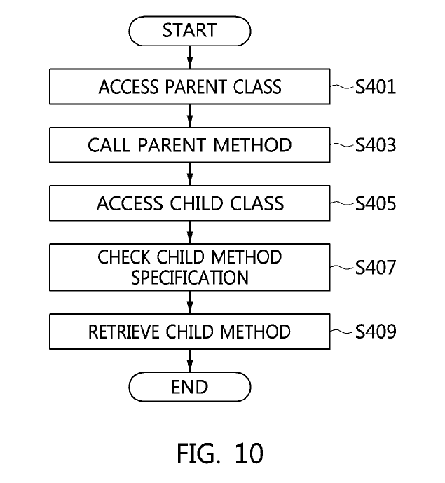

In this regard, referring to FIGS. 9 and 10, first, a child library is loaded through the API of the parent library, and a class in the parent library may be created at step S301, as shown in FIG. 9. Simultaneously with the creation of the class of the parent library, the specification of a class in the child library is checked in the created class at step S303, a class is retrieved at step S305, and the class in the child library is created at step S307.

FIG. 10 describes the process of calling a method in the child library through the created class in the child library. Specifically, the class created in the parent library is accessed through the API of the parent library at step S401, and the method provided in the corresponding class may be called at step S403. Then, the called method in the parent library accesses the class in the child library at step S405, checks the specification of a method in the child library at step S407, and may call the method in the child library at step S409 after retrieving the method.

Through these processes, the corresponding application may use the child library and thereby execute a function provided by the child library when run. For example, if the child library provides a function of receiving advertisement data from the service device 20 and outputting the data through an application, the corresponding application may output the advertisement data provided by the service device 20 while it is run.

According to the above-mentioned method for updating a library of the present invention, a terminal environment is implemented so as to include a shared storage area accessible by multiple applications and a non-shared storage area allocated to each of the applications, the shared storage area includes a child library that may be used by all the applications, and the non-shared storage area includes a parent library executed for each of the applications, whereby the same library is prevented from being duplicated in the terminal and resources may be more effectively used.

Also, when an application is released, the application includes only a parent library configured with APIs through which a child library, including classes, methods and objects for implementing actual functions, may be accessed, whereby network resources may be more effectively used.

Also, when it is necessary to update the child library, in which actual functions are implemented, because there is no need to perform update for each application, but only the child library, which may be accessed and shared by multiple applications, is updated, it is advantageous in that the expense for maintenance of the application may be reduced.

Hitherto, the method for updating a library according to an embodiment of the present invention has been described.

The above-described method for updating a library according to the present invention may be provided in the form of a computer-readable storage medium that is suitable for storing computer program instructions and data. In this case, the computer-readable storage medium suitable for storing computer program instructions and data, for example, the recording medium, may include magnetic media, such as a hard disk, a floppy disk, and magnetic tape, optical media, such as Compact Disk Read-Only Memory (CD-ROM) and a Digital Video Disk (DVD), magneto-optical media, such as a floptical disk, and semiconductor memory, such as Read-Only Memory (ROM), Random Access Memory (RAM), flash memory, Erasable Programmable ROM (EPROM), and Electrically Erasable Programmable ROM (EEPROM). The processor and memory may be complemented by a special-purpose logic circuit, or may be integrated thereto. Examples of the program instructions include machine code, such as code created by a compiler, and high-level language code executable by a computer using an interpreter or the like. The hardware devices may be configured to operate as one or more software modules in order to perform the operation of the present invention, and vice versa.

Although this specification contains details of many specific embodiments, these should not be construed as limitations on the scope of the invention or of what may be claimed, but as a description of features specific to particular embodiments of the invention. Certain features that are described in this specification in the context of separate embodiments can also be implemented by being combined in a single embodiment. Conversely, various features that are described in the context of a single embodiment can also be implemented in multiple embodiments, either separately or in any suitable sub-combination. Moreover, although features may be described as acting in certain combinations and as initially claimed, one or more features from a claimed combination can be excluded therefrom in some cases, and the claimed combination may be changed to a sub-combination or variation of a sub-combination.

Similarly, although operations in the drawings are depicted in a particular order, this should not be understood to mean that such operations are required to be performed in the particular order shown in the drawings or in a sequential order, or that all illustrated operations must be performed, in order to achieve desirable results. In certain circumstances, multitasking and parallel processing may be advantageous. Also, the separation of various system components in the above-described embodiment should not be understood as requiring separation in all embodiments, but should be understood that the described program components and systems may be generally integrated together in a single software product or packaged into multiple software products.

### INDUSTRIAL APPLICABILITY

The present invention relates to a method for updating a library in a terminal environment including a shared storage area, which is accessible by multiple applications, and a non-shared storage area allocated to each of the applications. More particularly, the present invention relates to a method for updating a library, and a terminal and system for the method, configured such that the shared storage area includes a child library that all applications may use, such that the non-shared storage area includes a parent library executed for each of the applications, and such that the parent library may receive a file related to the child library from a service device and control the received file so as to be used in place of the child library when it is determined that it is necessary to update the child library as a result of a comparison of the version of the child library with the version of the library in the service device, which is performed in conjunction with the service device.

According to the present invention, because the same library is prevented from being duplicated in a terminal, the resources of the terminal may be more effectively used, and network resources may be more effectively used by reducing the size of an application, which may contribute to the development of the software industry.

Furthermore, because the present invention is sufficient to be marketed or be put on sale, and may be implemented in practice, the present invention has industrial applicability.

### DESCRIPTION OF REFERENCE NUMERALS

| | | |
|---|---|---|
| 10: terminal | 11: communication unit | 12: input unit |
| 13: control unit | 13a: application processing module | |
| 14: storage unit | 14a: non-shared storage area | |
| 14b: shared storage area | 15: display unit | 20: service device |
| 21: service communication unit | 22: service control unit | |
| 23: service storage unit | 30: communication network | |
| 100: library update system | | |

1. A terminal, comprising:
a storage unit including a non-shared storage area allocated to each application and a shared storage area shareable by multiple applications, the non-shared storage area including a parent library that is allocated to each application and is capable of accessing and using a child library, and the shared storage area including the child library, shared by the multiple applications, for providing resources to the parent library; and
a control unit for checking a version of a library within a service device by controlling the parent library allocated to an application when the application is run, for comparing the checked version with a version of the child library within the shared storage area, for receiving a file related to the library from the service device by controlling the parent library when the checked version is found to differ from the version of the child library, for controlling the received file so as to be stored in the shared storage area, and for performing control so as to replace the child library previously stored in the shared storage area with the received library.

2. The terminal of claim 1, wherein, after controlling the received library so as to be stored in the shared storage area, the control unit controls processes of creating a class of the child library simultaneously with creating a class of the parent library, creating an object through the created class of the parent library, and retrieving and calling a method through the created object in order to perform a function provided by the received library.

3. A terminal, comprising:
a child library, located in a shared storage area shareable by multiple applications, for providing resources in response to a request from one or more parent libraries; and
the one or more parent libraries, located in a non-shared storage area allocated to each application, for checking a version of a library within a service device by operating in conjunction with the service device when an application is run, for receiving a file related to the library from the service device when the checked version is found to differ from a version of the child library as a result of a comparison therebetween, for controlling the received file so as to be stored in the shared storage area, and for performing control so as to replace the child library previously stored in the shared storage area with the received library.

4. The terminal of claim 3, wherein, in response to the one or more parent libraries, the child library provides a class, a method and an object for performing a specific function to the corresponding parent library.

5. The terminal of claim 3, wherein the parent library comprises:
a child library management unit for determining whether the child library is updated;
a child library loading unit for storing the library, received from the service device, in the shared storage area; and
a child library call unit for creating an object by retrieving a class and for retrieving and calling a method through the created object, in order to make the library stored in the shared storage area operate as the child library.

6. The terminal of claim 5, wherein the child library management unit comprises:
a server connection unit for connecting to the service device;
a version checking unit for checking the version of the library within the service device by querying the version when the service device is connected through the server connection unit; and
a storage area connection unit for connecting to the storage area after checking whether the library of the service device is shared among multiple applications when the version of the library, checked by the version checking unit, is found to differ from the version of the child library as a result of a comparison therebetween.

7. The terminal of claim 6, wherein the storage area connection unit determines that the child library is shared among multiple applications if one or more applications use the child library when checking applications using the previously stored child library.

8.-9. (canceled)

10. A method for updating a library in an environment of a terminal including a non-shared storage area, which includes a parent library that is allocated to each application and is capable of accessing and using a child library, and a shared storage area, which includes the child library, shared among multiple applications, for providing resources to the parent library, the method comprising:
checking, by the parent library, a version of a library within a service device by operating in conjunction with the service device when an application to which the parent library is allocated is run;
comparing, by the parent library, the checked version with a version of the child library; and
when the checked version is found to differ from the child library as a result of the comparing, performing, by the parent library, control so as to receive a file related to the library from the service device and to store the received file in the shared storage area and performing, by the parent library, control so as to replace the child library previously stored in the shared storage area with the received library.

11. The method of claim 10, wherein performing control comprises:
storing, by the parent library, the received library in the shared storage area;
creating, by the parent library, a class of the child library simultaneously with creating a class of the parent library in order to perform a function provided by the received library; and
controlling, by the parent library, processes of creating an object through the created class of the child library and retrieving and calling a method through the created object.

12. The method of claim 10, further comprising:
after comparing the checked version with the version of the child library, connecting, by the parent library, to the storage area after checking whether the library of the service device is shared among multiple applications when the checked version is found to differ from the child library as a result of the comparing.

13. (canceled)
